(19) United States
(12) Patent Application Publication
(10) Pub. No.: US 2015/0295911 A1
(43) Pub. Date: Oct. 15, 2015

(54) APPARATUS AND METHOD FOR CONTROLLING AUTHORIZATION TO ACCESS RESOURCES IN A COMMUNICATION NETWORK

(71) Applicant: FUJITSU LIMITED, Kawasaki-shi (JP)

(72) Inventors: Motoshi SUMIOKA, Kawasaki (JP); Takeshi Ohtani, Kawasaki (JP); Nami Nagata, Kawasaki (JP); KAZUO SASAKI, Kobe (JP)

(73) Assignee: Fujitsu Limited, Kawasaki (JP)

(21) Appl. No.: 14/644,659

(22) Filed: Mar. 11, 2015

(30) Foreign Application Priority Data
Apr. 9, 2014 (JP) 2014-080568

(51) Int. Cl. H04L 29/06

(52) U.S. Cl. CPC H04L 63/08; H04L 63/10

(57) ABSTRACT

An apparatus transmits, to a management apparatus, an access-request for accessing access-target information stored in an external apparatus by adding first state-information indicating a state of the apparatus to the access-request, receives a transmission request for requesting transmission of second state-information indicating state information that is required for accessing the access-target information and currently insufficient for the management apparatus, and executes an acquisition process of acquiring the second state-information. When the second state-information indicated by the transmission request is able to be acquired from plural acquisition sources, the apparatus executes the acquisition process on the plural acquisition sources, by giving priority to an acquisition source that requires a relatively smaller load for acquiring the second state-information in accordance with an acquisition load required for acquiring the second state-information from each of the plural acquisition sources, and transmits the acquired second state-information to the management apparatus.

### CROSS-REFERENCE TO RELATED APPLICATION

This application is based upon and claims the benefit of priority from the prior Japanese Patent Application No. 2014-080568 filed on Apr. 9, 2014, the entire contents of which are incorporated herein by reference.

### FIELD

The embodiments discussed herein are related to apparatus and method for controlling authorization to access resources in a communication network.

### BACKGROUND

When a terminal apparatus requests the use of a resource to a resource apparatus on a network, which stores a resource used in the terminal apparatus, a technique using a ticket that encrypts information for using the resource has been known. As an example of the technique using the ticket, an information processing apparatus has been known, which processes access authorization to permit using the resource by the ticket.

Related techniques are disclosed in, for example, Japanese Laid-Open Patent Publication No. 2000-215165, Japanese National Publication of International Patent Application No. 2004-537105, and Japanese National Publication of International Patent Application No. 2007-524877.

However, in order to use the resource used in the terminal apparatus, information required for acquiring the access authorization to permit using the resource may be changed depending on a state of the terminal apparatus. Acquisition of the information required for acquiring the access authorization that changes depending on the state of the terminal apparatus, increases the load of the processing in the terminal apparatus or in the information processing apparatus.

### SUMMARY

According to an aspect of the invention, a terminal apparatus transmits, to an information management apparatus, an access request for accessing access-target information stored in an external apparatus by adding first state information indicating a state of the terminal apparatus to the access request, receives a transmission request for requesting transmission of second state information indicating state information that is required for accessing the access-target information and currently insufficient for the information management apparatus, and executes an acquisition process of acquiring the second state information. When the second state information indicated by the transmission request is able to be acquired from a plurality of acquisition sources, the processor executes the acquisition process on the plurality of acquisition sources, by giving priority to an acquisition source that requires a relatively smaller load for acquiring the second state information in accordance with an acquisition load required for acquiring the second state information from each of the plurality of acquisition sources, and transmits the acquired second state information to the information management apparatus.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing system, according to an embodiment;

FIG. 2 is a diagram illustrating an example of an information processing system implemented by a computer, according to an embodiment;

FIG. 3 is a diagram illustrating an example of an operational flowchart of a resource access unit, according to an embodiment;

FIG. 4 is a diagram illustrating an example of a header included in a response, according to an embodiment;

FIG. 5 is a diagram illustrating an example of an operational flowchart of a ticket acquisition strategy unit, according to an embodiment;

FIG. 6 is a diagram illustrating an example of an acquisition cost table, according to an embodiment;

FIG. 7 is a diagram illustrating an example of an operational flowchart of a ticket acquisition unit, according to an embodiment;

FIG. 8 is a diagram illustrating an example of an operational flowchart of an authentication server, according to an embodiment;

FIG. 9 is a diagram illustrating an example of an operational flowchart of a ticket validation unit, according to an embodiment;

FIG. 10 is a diagram illustrating an example of an approval policy, according to an embodiment; and

FIG. 11 is a diagram illustrating an example of a directory, according to an embodiment.

### DESCRIPTION OF EMBODIMENTS

Hereinafter, an exemplary embodiment of a disclosed technique will be described in detail with reference to the drawings. The exemplary embodiment adopts a disclosed technique when an access control to a resource depending on a state of a terminal apparatus and a state of a user using the terminal apparatus is implemented.

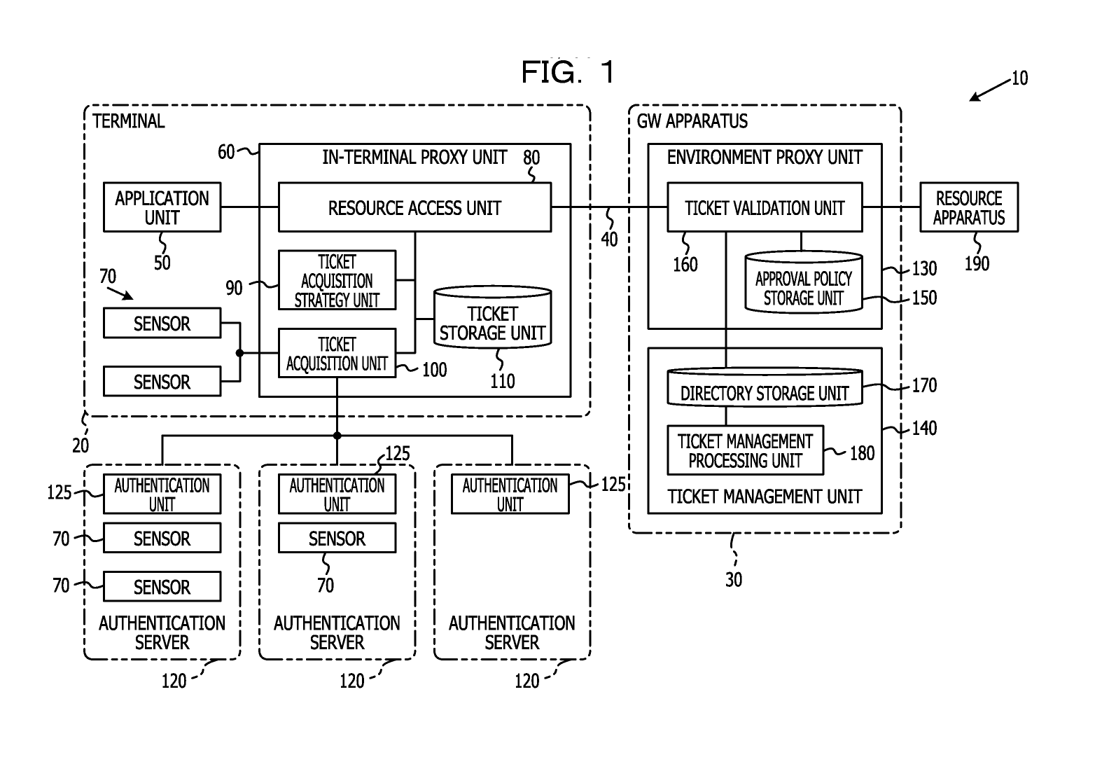

FIG. 1 illustrates an example of an information processing system 10 according to an embodiment. In the information processing system 10, a terminal apparatus 20 and a gateway apparatus 30 are connected to each other via a network 40. The terminal apparatus 20 includes an application unit 50, an in-terminal proxy unit 60, and a sensor 70.

While the sensor 70 may not be included in the terminal apparatus 20, the terminal apparatus 20 may include a plurality of sensors 70 as well. In addition, so long as the sensor 70 is an apparatus that outputs states of a terminal and a user using the terminal, any types of apparatuses may be used as the sensor 70. For example, the sensor 70 may include a global positioning system (GPS) sensor notifying positional information of the terminal or a reading apparatus outputting personal information by reading a written identification card of the user by using near field communication (NFC). In addition, there is the case where the sensor 70 manages information required at the time of outputting the states of a terminal and the user using the terminal.

For example, in a time table sensor that reads a name of a class and time information to output a subject of a course performed in the class at the corresponding time, time table information of each class is managed in the time table sensor.

The in-terminal proxy unit 60 includes a resource access unit 80, a ticket acquisition strategy unit 90, a ticket acquisition unit 100, and a ticket storage unit 110. Further, hereinafter, the gateway apparatus 30 is referred to as a gateway (GW) apparatus 30.

Meanwhile, the GW apparatus 30 includes an environment proxy unit 130 and a ticket management unit 140. The environment proxy unit 130 includes an approval policy storage unit 150 storing an approval policy at the time of accessing a resource apparatus 190 and a ticket validation unit 160 connected to the approval policy storage unit 150. Further, the ticket management unit 140 includes a directory storage unit 170 storing the directory and a ticket management processing unit 180 connected to the directory storage unit 170. Moreover, the GW apparatus 30 is connected to the resource apparatus 190 storing a resource.

Next, functions of the respective units of the terminal apparatus 20 will be described.

The application unit 50 includes an application that performs a required process by acquiring the resource included in the resource apparatus 190. When a resource is required, the application unit 50 transmits a request packet (hereinafter, also referred to as a packet) to the in-terminal proxy unit 60 together with a uniform resource locator (URL), which is information indicating a storage place of the resource. Further, the application unit 50 receives the resource requested by the packet from the resource apparatus 190.

There is no limit on a telegram format of the packet used in the embodiment, but as an example, the packet adopts a telegram based on a hypertext transfer protocol (HTTP).

The resource access unit 80 of the in-terminal proxy unit 60 adds the ticket to a packet from the application unit 50 and transmits the packet with the ticket to the GW apparatus 30. Herein, the ticket is information acquired by adding credit information to information (terminal state information) indicating the states of a terminal and the user using the terminal. Herein, the credit information is information for guaranteeing that contents of the terminal state information are not tampered and represent a correct state. In order to add the credit information to the terminal state information, a predetermined process may be performed for preventing manipulatory operations of the terminal state information and camouflaging of a notification source of the terminal state information, such as encryption of the terminal state information and attachment of a digital certificate to the terminal state information.

When the resource access unit 80 receives a response from the GW apparatus 30 indicating that a ticket required for acquiring the resource is insufficient, the resource access unit 80 requests acquisition of the insufficient tickets to the ticket acquisition strategy unit 90 and transmits the acquired insufficient tickets to the GW apparatus 30. Hereinafter, a ticket which is required for acquiring the resource and currently is insufficient for the GW apparatus 30 is referred to as an “insufficient ticket”.

The ticket acquisition strategy unit 90 specifies an acquisition source of the ticket to acquire the ticket by a method in which the least load is applied, when there exist a plurality of acquisition sources of the insufficient tickets. In addition, the ticket acquisition strategy unit 90 instructs the ticket acquisition unit 100 to acquire the insufficient tickets from the specific acquisition source of the ticket.

Herein, as an index indicating the load of the ticket acquisition, for example, an acquisition time from a time of a ticket being requested to a time of the ticket being acquired may be used, and it is determined that the smaller is the load of the ticket acquisition, the shorter is the acquisition time of the ticket.

The ticket acquisition unit 100 acquires the ticket instructed from the ticket acquisition strategy unit 90, from the acquisition source of the ticket specified by the ticket acquisition strategy unit 90. The acquisition sources of the ticket include, for example, the ticket storage unit 110, an authentication server 120, and the sensor 70 exist.

The ticket acquisition unit 100 acquires a ticket, which is sent spontaneously from a sensor 70 incorporated in or connected to the authentication server 120 (a sensor 70 affiliated with the authentication server 120), for example, when the sensor 70 detects a state change of a sensor value, and stores the acquired ticket in the ticket storage unit 110.

The authentication server 120 receives a ticket issue request from the ticket acquisition unit 100 and acquires the terminal state information by, for example, the sensor 70 incorporated in or connected to the authentication server 120. In addition, the authentication server 120 makes a ticket of the acquired terminal state information with an authentication unit 125 and transmits the ticket to the ticket acquisition unit 100.

Even when the authentication server 120 does not receive the ticket issue request from the ticket acquisition unit 100, the authentication server 120 may issue a ticket and transmit the ticket to the ticket acquisition unit 100 when there is a change in the value of the sensor 70 affiliated with the authentication server 120.

The terminal state information output from the sensor 70 affiliated with the terminal 20 is un-encrypted information before a ticket is made thereof. Therefore, in this case, the ticket acquisition unit 100 transmits the terminal state information acquired from the sensor 70 to the authentication server 120 and makes a ticket of the terminal state information to improve the reliability of the terminal state information.

The ticket acquired by the ticket acquisition unit 100 is stored in the ticket storage unit 110.

Next, functions of the respective units of the GW apparatus 30 will be described.

The ticket validation unit 160 receives the packet added with the ticket from the terminal apparatus 20 and refers to the approval policy stored in the approval policy storage unit 150 to validate whether the ticket required for acquiring the resource requested by the terminal apparatus 20 is added to the packet. In addition, when the ticket required for acquiring the resource is added to the packet, the ticket validation unit 160 transmits the packet to the resource apparatus 190 and transmits the response from the resource apparatus 190, which includes the requested resource, to the terminal apparatus 20.

Meanwhile, when the ticket required for acquiring the resource is not added to the packet, the ticket validation unit 160 acquires the acquisition source of the insufficient ticket by referring to the directory included in the directory storage unit 170 of the ticket management unit 140.

The ticket management processing unit 180 provides an interface for storing the directory in the directory storage unit 170 of the GW apparatus 30 in advance or editing contents of the directory.

The resource apparatus 190 reads the resource requested by the packet among resources recorded in advance in a readable recording medium, generates a response to which the read resource is added, and transmits the generated response to the ticket validation unit 160 of the GW apparatus 30, for example.

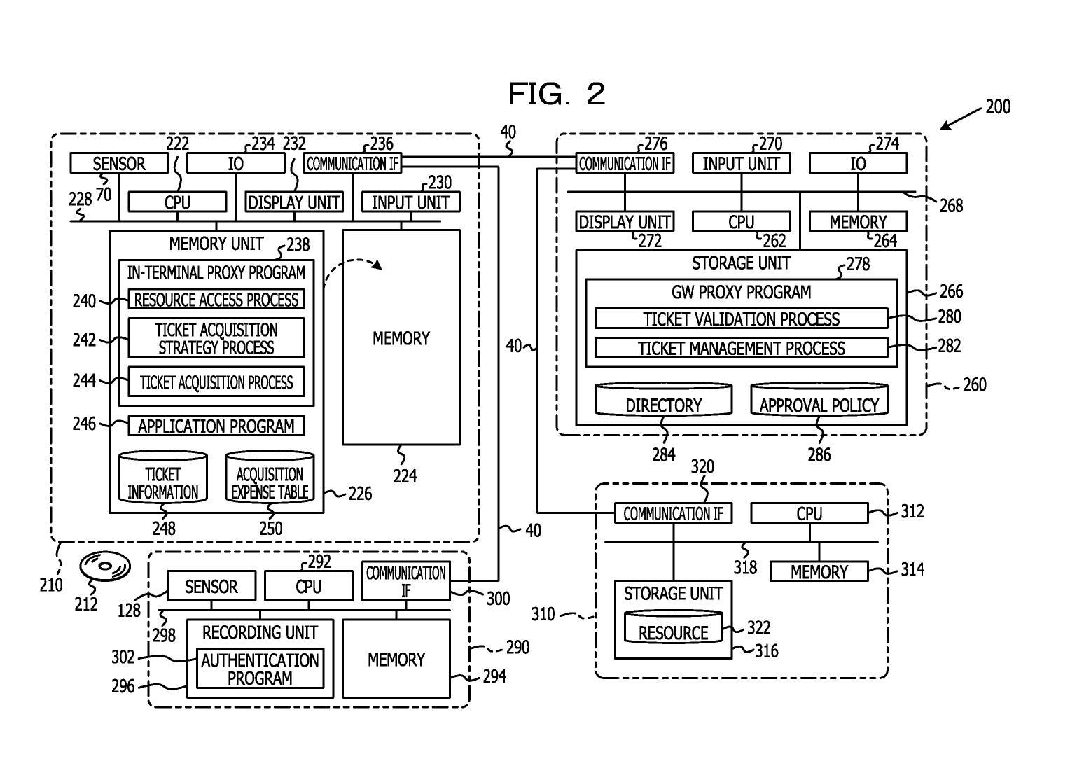

FIG. 2 illustrates a computer system 200 as an example in which the terminal apparatus 20 and the GW apparatus 30 included in the information processing system 10 may be implemented by a computer. The computer system 200 illustrated in FIG. 2 as the information processing system 10 includes a computer 210 serving as the terminal apparatus 20 and a computer 260 serving as the GW apparatus 30. Further, the computer system 200 includes a computer 290 as the authentication server 120 and a computer 310 as the resource apparatus 190.

The computer 210 includes a CPU 222, a memory 224, an in-terminal proxy program 238, and a non-volatile memory unit 226 with an application program 246 recorded therein. The CPU 222, the memory 224, and the memory unit 226 are connected to each other through a bus 228. Further, the computer 210 includes a display unit 232, such as a display, and an input unit 230, such as a keyboard and a mouse, and the display unit 232 and the input unit 230 are connected to the bus 228. In addition, in the computer 210, an IO 234 for recording in and reading from a recording medium 212 is connected to the bus 228. Moreover, the computer 210 includes a communication interface (IF) 236 including an interface for connection to a network 40. Further, the memory unit 226 is implemented by a hard disk drive (HDD) or a flash memory.

The memory unit 226 stores a program and information for causing the computer 210 to function as the terminal apparatus 20 illustrated in FIG. 1. That is, the memory unit 226 stores the in-terminal proxy program 238, the application program 246, ticket information 248, and an acquisition cost table 250. The in-terminal proxy program 238 stored in the memory unit 226 includes a resource access process 240, a ticket acquisition strategy process 242, and a ticket acquisition process 244. The CPU 222 reads the in-terminal proxy program 238 from the memory unit 226, extends the read in-terminal proxy program 238 to the memory 224, and executes each process of the in-terminal proxy program 238.

The CPU 222 reads the in-terminal proxy program 238 from the memory unit 226 and extends the read in-terminal proxy program 238 to the memory 224, and executes the in-terminal proxy program 238 so that the computer 210 operates as the terminal apparatus 20 illustrated in FIG. 1. The CPU 222 reads the resource access process 240 from the memory unit 226 and extends the read resource access process 240 to the memory 224, and executes the resource access process 240 so that the computer 210 operates as the resource access unit 80 illustrated in FIG. 1. Further, the CPU 222 executes the ticket acquisition strategy process 232 so that the computer 210 operates as the ticket acquisition strategy unit 90 illustrated in FIG. 1. Moreover, the CPU 222 executes the ticket acquisition process 244 so that the computer 210 operates as the ticket acquisition unit 100 illustrated in FIG. 1. Further, the CPU 222 executes the application program 246 so that the computer 210 operates as the application unit 50 illustrated in FIG. 1.

The computer 260 includes a CPU 262, a memory 264, and a non-volatile storage unit 266 with a GW proxy program 278 recorded therein. The CPU 262, the memory 264, and the storage unit 266 are connected to each other through a bus 268. Further, the computer 260 includes a display unit 272, such as the display, and an input unit 270, such as the keyboard and the mouse, and the display unit 272 and the input unit 270 are connected to the bus 268. In addition, in the computer 260, an IO 274 for recording in and reading from the recording medium 212 is connected to the bus 268. Moreover, the computer 260 includes a communication interface (IF) 276 including the interface for connection to the network 40. Further, the storage unit 266 is implemented by the hard disk drive (HDD) or the flash memory.

The storage unit 266 stores a program and information for causing the computer 260 to function as the GW apparatus 30 illustrated in FIG. 1. That is, the storage unit 266 stores the GW proxy program 278, a directory 284, and an approval policy 286. The GW proxy program 278 stored in the storage unit 266 includes a ticket validation process 280 and a ticket management process 282. The CPU 262 reads the GW proxy program 278 from the storage unit 266, extends the read GW proxy program 278 to the memory 264, and executes each process of the GW proxy program 278.

The CPU 262 reads the GW proxy program 278 from the storage unit 266 and extends the read GW proxy program 278 to the memory 264, and executes the GW proxy program 278 so that the computer 260 operates as the GW apparatus 30 illustrated in FIG. 1. The CPU 262 reads the ticket validation process 280 from the storage unit 266 and extends the read ticket validation process 280 to the memory 264, and executes the ticket validation process 280 so that the computer 260 operates as the ticket validation unit 160 illustrated in FIG. 1. Further, the CPU 262 executes the ticket management process 282 so that the computer 260 operates as the ticket management processing unit 180 illustrated in FIG. 1.

The computer 290 includes a CPU 292, a memory 294, and a non-volatile recording unit 296 with an authentication program 302 recorded therein. The CPU 292, the memory 293, and the recording unit 296 are connected to each other through a bus 298. Further, the computer 290 includes the sensor 70 that collects the terminal state information, and the sensor 70 is connected to the bus 298. Moreover, the computer 290 includes a communication interface (IF) 300 including the interface for connection to the network 40. Further, the recording unit 296 is implemented by the hard disk drive (HDD) or the flash memory.

The recording unit 296 stores a program for causing the computer 290 to function as the authentication server 120 illustrated in FIG. 1. That is, the recording unit 296 stores the authentication program 302. The CPU 292 reads the authentication program 302 from the recording unit 296 and extends the read authentication program 302 to the memory 294, and executes the authentication program 302 so that the computer 290 operates as the authentication server 120 illustrated in FIG. 1.

The computer 310 includes a CPU 312, a memory 314, and a non-volatile storage unit 316 with a resource 322 recorded therein, and the computer 310 operates as the resource apparatus 190 illustrated in FIG. 1.

The CPU 312, the memory 314, and the storage unit 316 are connected to each other through a bus 318. Moreover, the computer 310 includes a communication interface (IF) 320 including the interface for connection to the network 40. Further, the storage unit 316 is implemented by the hard disk drive (HDD) or the flash memory.

The terminal apparatus 20, the GW apparatus 30, the authentication server 120, and the resource apparatus 190 may be implemented by, for example, a semiconductor integrated circuit, in more detail, an application specific integrated circuit (ASIC).

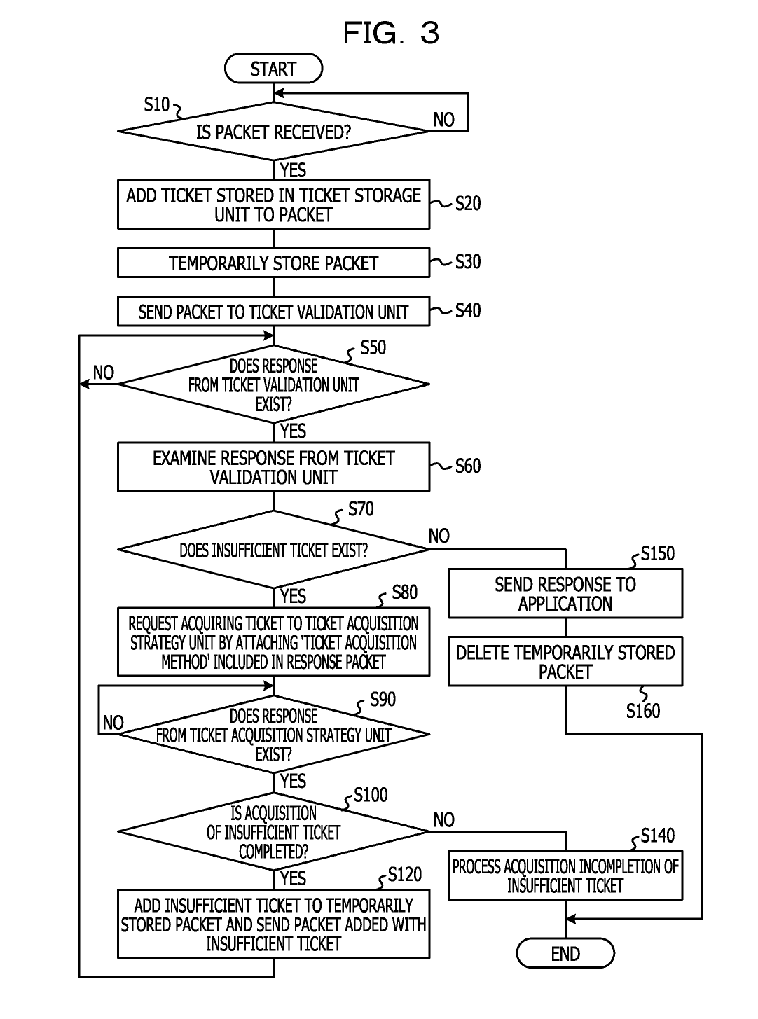

Next, an operation of the terminal apparatus 20 according to the exemplary embodiment will be described. The resource access unit 80 of the terminal apparatus 20 according to the embodiment executes a resource access process illustrated in FIG. 3 after activating the terminal apparatus 20.

The application unit 50 according to the embodiment is, for example, a learning application of mathematics, and the case of acquiring a mathematics supplementary education textbook as a resource from the resource apparatus 190 will be described. Further, there is no limit on a type of the application used in the application unit 50, and the application is not limited to the mathematics learning application.

First, at step S10, it is determined whether the resource access unit 80 receives the packet from the application unit 50. In addition, in the case of a negative determination, the process proceeds to step S10 again to wait for receiving the packet. Meanwhile, in the case of a positive determination, the process proceeds to step S20.

The approval policy 286, which describe information on a ticket required for accessing the resource requested by the packet, does not exist in the terminal apparatus 20. Accordingly, at step S20, first, the resource access unit 80 adds all the tickets stored in the ticket storage unit 110 or an arbitrarily selected ticket to a header of the packet.

In the information processing system 10 according to the embodiment, the approval policy is not included in the terminal apparatus 20 for the purpose of making the information processing system 10 easier to be constructed, which flexibly deals with a change in the system.

There may be a case where the approval policy 286 is included in the terminal apparatus 20 and the resource access unit 80 refers to the approval policy 286 in the terminal apparatus 20 to add the ticket required for acquiring the resource requested by the application unit 50. In this case, whenever the approval policy 286 is changed, the approval policies 286 of the terminal apparatus 20 and the GW apparatus 30 need to coincide with each other. Meanwhile, as in the information processing system 10 according to the embodiment, in the configuration where the approval policy 286 is disposed only in the GW apparatus 30, even if the approval policy 286 is changed, a change process of the approval policy 286 of the entire system is ended only by changing the approval policy 286 of the GW apparatus 30. This is because the approval policy 286 does not exist in the terminal apparatus 20 according to the embodiment.

When an expiration date is set in the ticket, the resource access unit 80 adds the valid ticket within the expiration date to the packet. Therefore, for example, the resource access unit 80 may periodically perform a process such as deleting expired tickets. This prevents a ticket, which is not required to be subjected to ticket validation processing, from being added to a packet, thereby suppressing a communication traffic amount of the network 40. However, even if the expired ticket is added to the packet, no problem would occur because the expired ticket is handled to be invalid in the GW apparatus 30.

At step S30, the resource access unit 80 temporarily stores the packet after the process of step S20 in a predetermined area of the memory 224.

At step S40, the resource access unit 80 transmits the packet added with the ticket to the ticket validation unit 160 of the GW apparatus 30.

At step S50, it is determined whether the resource access unit 80 receives the response from the ticket validation unit 160 with respect to the packet transmitted at step S40. In the case of a negative determination, the process proceeds to step S50 again to repeat the process of step S50 until the response is received. Further, when the response is not received from the ticket validation unit 160 even though a predetermined time elapses, the resource access unit 80 may transmit an error response to notify a resource acquisition failure to the application unit 50 so as to end the process. Further, for example, the response may be configured to be a telegram according to the HTTP.

Meanwhile, when the response from the ticket validation unit 160 is received in the process of step S50, the process proceeds to step S60, and at step S60, the resource access unit 80 refers to a header of the received response.

At step S70, the resource access unit 80 determines whether there exist insufficient tickets that are required for acquiring the resource, from the contents of the header referred to in the process of step S60.

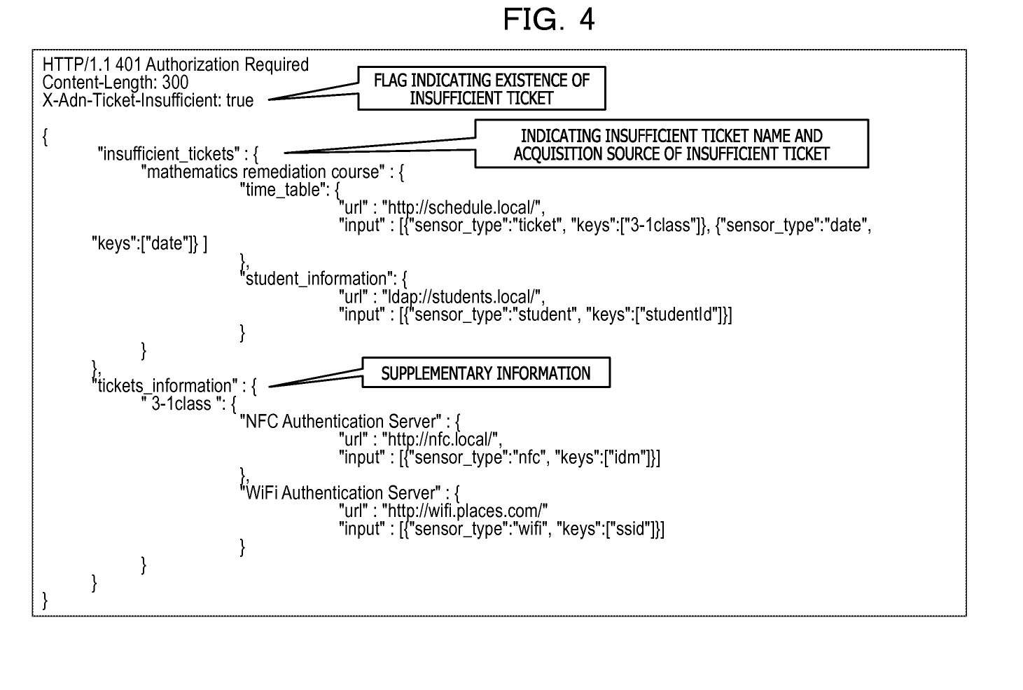

Herein, an example of the response header is illustrated in FIG. 4.

A flag indicating whether insufficient tickets exist is included in the response header. Further, when the insufficient tickets exist, information on an acquisition source of the insufficient tickets is included in the response. Moreover, supplementary information is included in the header when another ticket is also required to acquire the insufficient tickets and information on an acquisition source of another ticket is described in the supplementary information. Further, the information on the acquisition source of the ticket includes a URL of the ticket acquisition source and an input parameter required to receive the ticket.

In the example of FIG. 4, “X-Adn-Ticket-insufficient” represents a flag indicating whether the insufficient ticket exists, and when a value of the flag is true, the insufficient ticket exists, and when the value of the flag is false, the insufficient ticket does not exist.

In the example of FIG. 4, the contents described in the parenthesis, which correspond to “insufficient_tickets”, indicate the information on the acquisition sources of the insufficient tickets. In this case, a ticket for a mathematics remediation course is insufficient and acquisition sources thereof includes two types of sensors 70: a sensor 70 referred to as “time table” and a sensor 70 referred to as “student information”.

In the example of FIG. 4, as an input parameter for issuing the ticket for the mathematics remediation course from the time table sensor 70, a third grade class 1 (3-1class) ticket is required as described in the parenthesis corresponding to “input”. Therefore, an item of “tickets_information” representing the supplementary information is added to the response header and information on an acquisition source of the third grade class 1 (3-1class) ticket is further described. In this case, the description of FIG. 4 indicates that the third grade class 1 (3-1class) ticket is able to be acquired from an NFC server or a WiFi server.

The resource access unit 80 determines that the insufficient ticket exists when “X-Adn-Ticket-insufficient” is true, and the process proceeds to step S80. Meanwhile, when “X-Adn-Ticket-insufficient” is false, the insufficient ticket does not exist, that is, the resource access unit 80 determines that the resource requested by the application unit 50 is included in the response received by the process of step S50, and the process proceeds to step S150.

At step S150, the resource access unit 80 sends the received response to the application unit 50. As a result, the application unit 50 may acquire the requested resource from the received response.

At step S160, the resource access unit 80 deletes the packet temporarily stored in the memory 224 by the process of step S30, and ends the process.

Meanwhile, when it is determined that the insufficient ticket exists by the process of step S70, the resource access unit 80 requests the acquisition of the insufficient ticket to the ticket acquisition strategy unit 90 at step S80. In this case, the resource access unit 80 notifies the ticket acquisition strategy unit 90 of information on the acquisition source of the insufficient tickets included in the header of the response received by the process of step S50 and the supplementary information when the supplementary information exists, as a ‘ticket acquisition method’.

At step S90, the resource access unit 80 determines whether an acquisition result of the insufficient ticket is received from the ticket acquisition strategy unit 90. In the case of a negative determination, the process proceeds to step S90 again to repeat the process of step S90 until the acquisition result of the insufficient ticket is received. In the case of a positive determination, the process proceeds to step S100. Further, in the case where the acquisition result may not be received from the ticket acquisition strategy unit 90 even though a predetermined time elapses, the resource access unit 80 determines the case as an acquisition failure, and the process may proceed to step S100.

At step S100, the resource access unit 80 determines whether the acquisition of the insufficient ticket is completed, based on the acquisition result of the insufficient ticket from the ticket acquisition strategy unit 90, which is acquired by the process of step S90. Further, by the process of step S90, when it is determined that the acquisition failure has occurred due to a lapse of a predetermined time required for receiving the acquisition result, it is determined at step 100 that the acquisition of the insufficient ticket is not completed. In addition, in the case of a negative determination, the process proceeds to step S140, and at step S140, the resource access unit 80 transmits the error response to notify the acquisition failure of the insufficient ticket to the application unit 50, and ends the process. Meanwhile, in the case of a positive determination in the process of step S100, the process proceeds to step S120.

At step S120, the resource access unit 80 adds the insufficient ticket acquired by the process of step S90 to the packet temporarily stored in the memory 224 by the process of step S30 and transmits the packet added with the insufficient ticket to the ticket validation unit 160. Then, the process proceeds to step S50 to repeat the processes of steps S50 to S160, thereby adding the ticket required for acquiring the requested resource to the packet. By performing the above processes, the resource access process illustrated in FIG. 3 is ended.

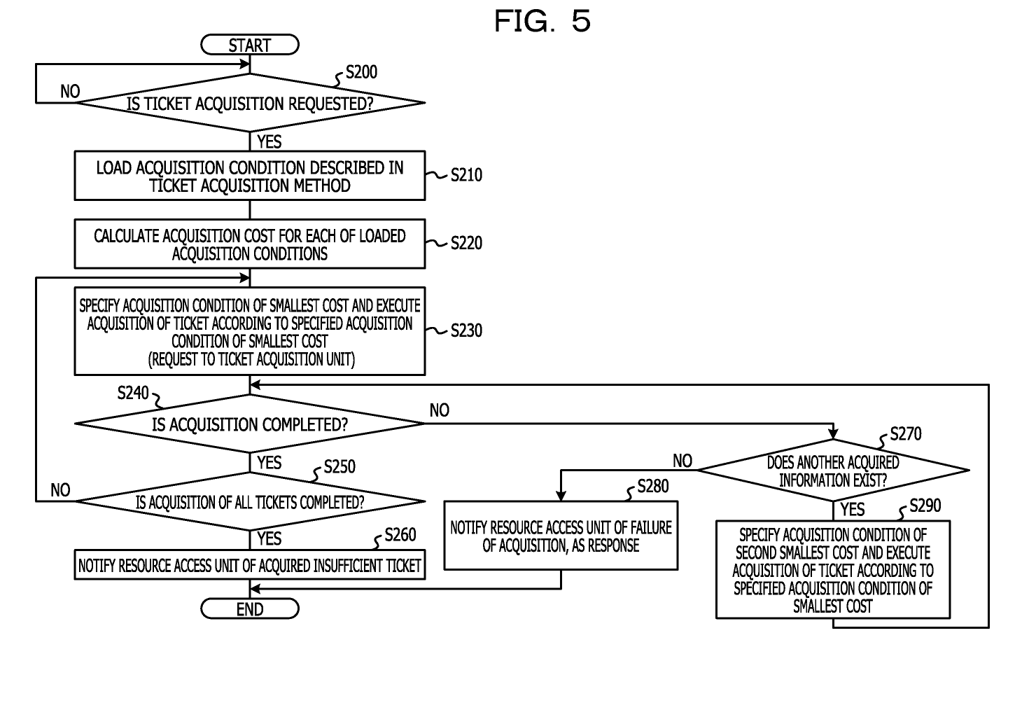

Next, FIG. 5 is an operational flowchart illustrating a ticket acquisition strategy process executed by the ticket acquisition strategy unit 90 of the terminal apparatus 20. Further, the ticket acquisition strategy unit 90 executes the ticket acquisition strategy process illustrated in FIG. 5 after the terminal apparatus 20 is activated.

First, at step S200, the ticket acquisition strategy unit 90 determines whether there exists the acquisition request of the insufficient ticket from the resource access unit 80. In the case of negative determination, the process proceeds to step S200 again to wait for the acquisition request of the insufficient ticket. Meanwhile, in the case of positive determination, the ticket acquisition strategy unit 90 acquires the ticket acquisition method notified together with the acquisition request of the insufficient ticket, and the process proceeds to step S210.

At step S210, the ticket acquisition strategy unit 90 converts the contents of the ticket acquisition method acquired at step S200 into a format that is able to be interpreted by the ticket acquisition strategy unit 90, and loads the format indicating the ticket acquisition method into a predetermined area of the memory 224.

At step S220, the ticket acquisition strategy unit 90 calculates a cost (e.g., an acquisition cost) for acquiring the insufficient ticket from the ticket acquisition method that has been loaded into the memory 224 by the process of step S210. In this case, when information on a plurality of acquisition sources is displayed for the same insufficient ticket in the ticket acquisition method, the ticket acquisition strategy unit 90 calculates the acquisition cost for each of the plurality of acquisition sources.

The acquisition cost is calculated based on the acquisition cost table 250.

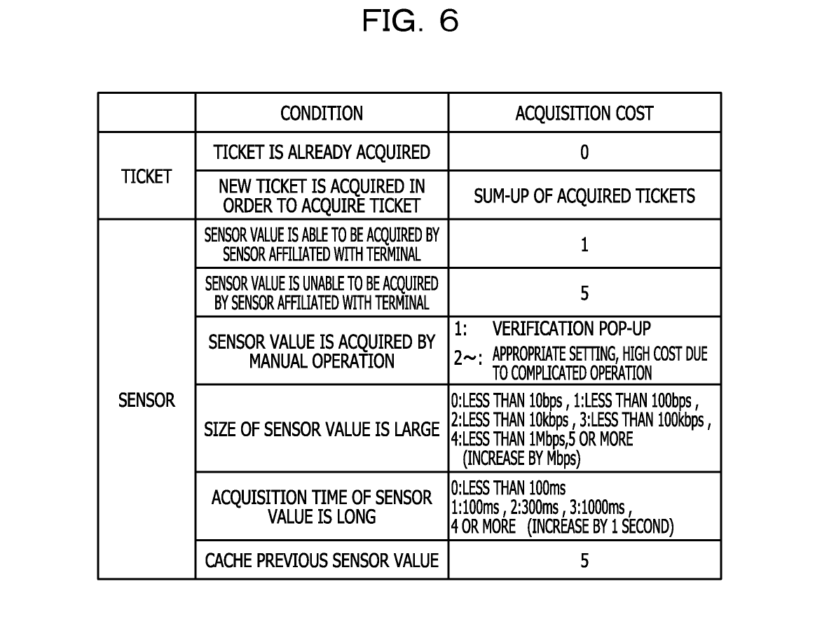

FIG. 6 is a diagram illustrating an example of the acquisition cost table 250. The acquisition cost table 250 is a table indicating a load (acquisition cost) required for acquiring a ticket, in association with each acquisition means and each condition of the sensor 70 required for issuing the ticket. A degree of the load of the ticket acquisition is determined depending on, for example, an acquisition time required until receiving a ticket after requesting the ticket. In the case, as the acquisition time of the ticket becomes longer, more load is applied to the ticket acquisition, and as a result, the acquisition cost is set to a larger value.

In an example of the acquisition cost table 250 illustrated in FIG. 6, when the acquisition of the insufficient ticket has already been completed, the insufficient ticket need not be newly acquired, and the acquisition cost is set at ‘0’. Meanwhile, in order to acquire the insufficient ticket, terminal state information should be acquired from the relevant sensor 70 according to information on the acquisition source of the insufficient ticket for each insufficient ticket. When the terminal state information is able to be acquired from, for example, the sensor 70 affiliated with the terminal apparatus 20, since the acquisition of the terminal state information is completed within the terminal apparatus 20, the acquisition load is smaller than the acquisition load when the terminal state information is acquired from the sensor 70 affiliated with the authentication server 120. Accordingly, the acquisition cost in this case is set at a low value.

When the terminal state information is acquired from the sensor corresponding to the insufficient ticket, in the case where a user operates the mouse while viewing a screen displayed on the display unit 232, the time required for acquiring the terminal state information becomes longer as the operation depending on the acquisition of the terminal state information becomes complicated. Therefore, as the operation becomes complicated, the acquisition cost is set at a larger value. Further, for the same reason, as a data size of the terminal state information output from the sensor, which is associated with the insufficient ticket in advance, becomes larger, the acquisition cost is set at a larger value.

It is assumed that the sensor information, predefining which condition described in the acquisition cost table 250 belongs to the sensor 70 designated by the information on the acquisition source of the insufficient ticket, is stored in the memory unit 226 in advance and loaded into the predetermined area of the memory 224.

Therefore, the ticket acquisition strategy unit 90 first specifies the sensor 70 required for acquiring the insufficient ticket from the ticket acquisition method. In addition, the ticket acquisition strategy unit 90 calculates the acquisition cost of the insufficient ticket from the acquisition cost table 250 by extracting a condition of the specified sensor 70 based on the sensor information.

When plural conditions in the acquisition cost table 250 is combined with each other in order to acquire one insufficient ticket, a sum-up value of acquisition costs acquired according to the respective plural conditions is set as the acquisition cost of the insufficient ticket. For example, when the terminal state information before a ticket is made thereof is able to be acquired form the sensor 70 affiliated with the terminal apparatus 20, and further, for example, 100 ms is required until the terminal state information is output from the corresponding sensor 70, the acquisition cost corresponding to each condition is ‘1’. Therefore, the acquisition cost of the insufficient ticket when the terminal state information is acquired from the sensor 70 and a ticket is made thereof becomes ‘2’. Further, when another ticket is newly required to acquire one insufficient ticket, the acquisition cost of the insufficient ticket becomes a value acquired by adding the acquisition cost required to acquire another ticket to the previous acquisition cost.

The ticket acquisition strategy unit 90 first refers to the ticket storage unit 110 to determine whether the insufficient ticket is stored at the time of calculating the acquisition cost of the insufficient ticket. When the insufficient ticket is stored in the ticket storage unit 110, a new ticket needs not be acquired. As a result, it is determined that the insufficient ticket has the acquisition source having the smallest acquisition cost. Therefore, it is no longer necessary to calculate the acquisition cost of the insufficient ticket by another method.

At step S230, the ticket acquisition strategy unit 90 specifies the acquisition source having the smallest acquisition cost in acquiring the insufficient ticket, based on the acquisition costs of the insufficient ticket calculated by the process of step S220, when a plurality of acquisition sources exists for the same insufficient ticket. In addition, the ticket acquisition strategy unit 90 notifies the ticket acquisition unit 100 to acquire the insufficient ticket from the acquisition source of the insufficient ticket having the smallest acquisition cost. In this case, the ticket acquisition strategy unit 90 notifies the ticket acquisition unit 100 of the acquisition source information of the ticket corresponding to the insufficient ticket together.

At step S240, the ticket acquisition strategy unit 90 waits for acquiring the acquisition result notified from the ticket acquisition unit 100 and determines whether the acquisition of the insufficient ticket is completed, based on the acquisition result. In the case of a positive determination, the process proceeds to step S250.

At step S250, the ticket acquisition strategy unit 90 determines whether all insufficient tickets are acquired by referring to the ticket acquisition method loaded into the memory 224 by the process of step S210. In addition, in the case of a negative determination, the process proceeds to step S230, and the ticket acquisition strategy unit 90 selects one insufficient ticket not acquired and specifies the acquisition source having the smallest acquisition cost in acquiring the insufficient ticket. Further, the ticket acquisition strategy unit 90 repeats the process of notifying the ticket acquisition unit 100 to acquire the insufficient ticket from the acquisition source of the insufficient ticket having the smallest acquisition cost. Meanwhile, in the case of a positive determination, the process proceeds to step S260.

At step S260, the ticket acquisition strategy unit 90 notifies the resource access unit 80 of the insufficient ticket notified from the ticket acquisition unit 100 together with the acquisition result of the insufficient ticket by the process of step S240. The ticket acquisition strategy unit 90 stores the acquired ticket in the ticket storage unit 110.

Meanwhile, in the case of a negative determination by the process of step S240, the process proceeds to step S270.

At step S270, the ticket acquisition strategy unit 90 determines whether an acquisition source other than the acquisition source of the insufficient ticket specified at step S230 exists, by referring to the ticket acquisition method loaded into the memory 224 by the process of step S210. In addition, in the case of a negative determination, the process proceeds to step S280.

At step S280, since another acquisition source from which the insufficient ticket may be acquired does not exist, the ticket acquisition strategy unit 90 notifies the resource access unit 80 of the acquisition result indicating that the insufficient ticket has failed to be acquired.

Meanwhile, in the case of a positive determination by the process of step S270, the process proceeds to step S290.

At step S290, since an acquisition source other than the acquisition source of the insufficient ticket, from which the acquisition of the insufficient ticket is attempted up to now, exists, the ticket acquisition strategy unit 90 specifies the acquisition source having the smallest acquisition cost among the remaining acquisition sources from which the acquisition of the insufficient ticket is not attempted. In addition, the ticket acquisition strategy unit 90 requests the ticket acquisition unit 100 to acquire the insufficient tickets from the specified acquisition source of the insufficient ticket, and the process returns to step S240. In this case, the ticket acquisition strategy unit 90 notifies the ticket acquisition unit 100 of information on the acquisition source of the ticket corresponding to the insufficient ticket together.

By the above process, the ticket acquisition strategy process illustrated in FIG. 5 is ended.

As described above, the ticket acquisition strategy unit 90 controls the ticket acquisition unit 100 to acquire the insufficient ticket from the acquisition source of the ticket having the smallest acquisition cost, and to acquire the insufficient ticket from the acquisition source of the ticket having the second smallest acquisition cost when the insufficient ticket has not been acquired from the acquisition source of the ticket having the smallest acquisition cost.

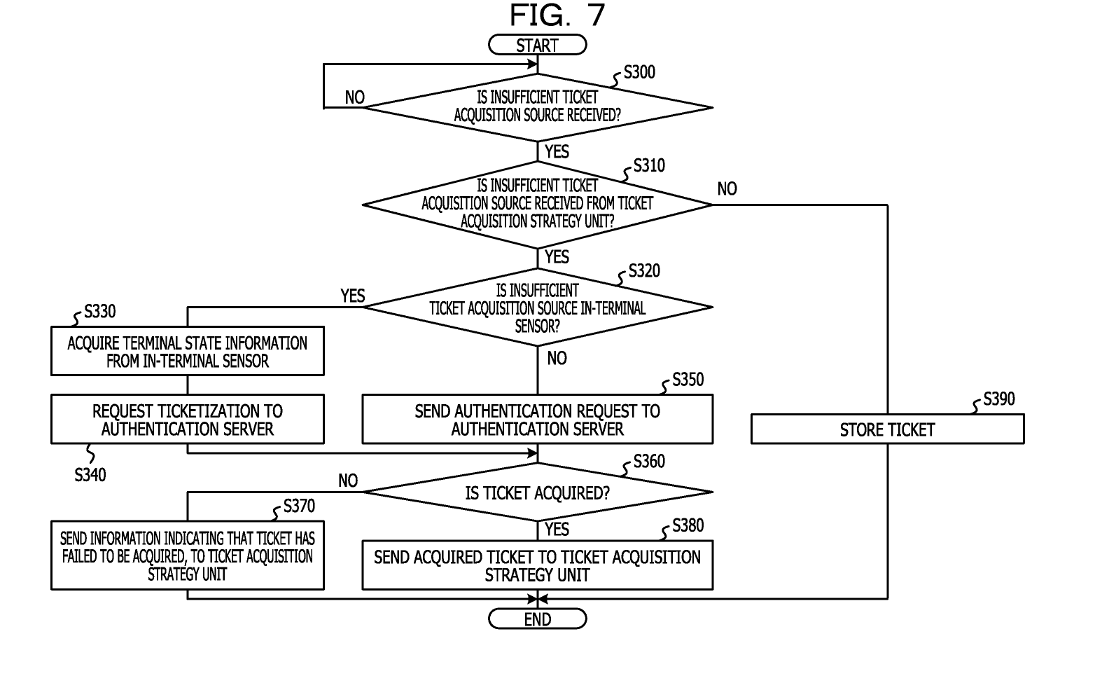

Next, FIG. 7 is an operational flowchart illustrating a ticket acquisition process loaded by the ticket acquisition unit 100 of the terminal apparatus 20. Further, the ticket acquisition unit 100 executes the ticket acquisition process illustrated in FIG. 7 after the terminal apparatus 20 is activated.

First, at step S300, it is determined whether the ticket acquisition unit 100 receives a predetermined notification. In the case of a negative determination, the process proceeds to step S300 again, and the ticket acquisition unit 100 waits for receiving the notification. Meanwhile, in the case of a positive determination, the process proceeds to step S310.

At step S310, it is determined whether a transmission source of the notification received by the process of step S300 is the ticket acquisition strategy unit 90. The transmission source of the notification may be acquired by referring to, for example, notification source information included in the notification. In addition, in the case of a positive determination, the process proceeds to step S320, and in the case of a negative determination, the process proceeds to step S390.

At step S320, the ticket acquisition unit 100 determines whether the acquisition source of the insufficient ticket notified from the ticket acquisition strategy unit 90 is the sensor 70 affiliated with the terminal apparatus 20. In the case of a positive determination, the process proceeds to step S330, and in the case of a negative determination, the process proceeds to step S350.

At step S330, the ticket acquisition unit 100 acquires the terminal state information from the sensor 70 affiliated with the terminal apparatus 20 instructed by the ticket acquisition strategy unit 90. However, a ticket is not made yet for the terminal state information acquired from the sensor 70. Therefore, at step S340, the ticket acquisition unit 100 issues an authentication request by transmitting the terminal state information to an authentication server 120 configured to make a ticket of the terminal state information acquired from the sensor 70, among the plurality of authentication servers 120.

Meanwhile, at step S350, the ticket acquisition unit 100 notifies the authentication request to the authentication server 120 as the acquisition source of the insufficient ticket, which is designated by the ticket acquisition strategy unit 90, together with the acquisition source information of the ticket. In this case, the ticket acquisition unit 100 refers to the acquisition source information of the ticket and notifies the authentication server 120 of information required to acquire the insufficient ticket, if any.

At step S360, the ticket acquisition unit 100 waits for a response from the authentication server 120 to which the authentication request has been issued at step S340 or S350. When the ticket is received from the authentication server 120, the process proceeds to step S380. At step S380, the ticket acquisition unit 100 sends the ticket received from the authentication server 120 to the ticket acquisition strategy unit 90 together with an acquisition result of acquisition completion.

Meanwhile, in the process of step S360, when notification indicating that the authentication server 120 has failed to issue the ticket is received or when no response is received from the authentication server 120 even though a predetermined time elapses, the process proceeds to step S370.

At step S370, the ticket acquisition unit 100 sends an acquisition result indicating that the ticket has failed to be acquired, to the ticket acquisition strategy unit 90.

In the process of step S310, when the transmission source of the notification received by the process of step S300 is not the ticket acquisition strategy unit 90, that is, when the transmission source is the authentication server 120, a process of step S390 is executed. For example, when the authentication server 120 spontaneously transmits the ticket to the ticket acquisition unit 100, the process of step S390 is executed.

At step S390, when the ticket is notified from the authentication server 120, the ticket acquisition unit 100 stores the notified ticket in the ticket storage unit 110.

According to the above processes, the ticket acquisition process illustrated in FIG. 7 is ended.

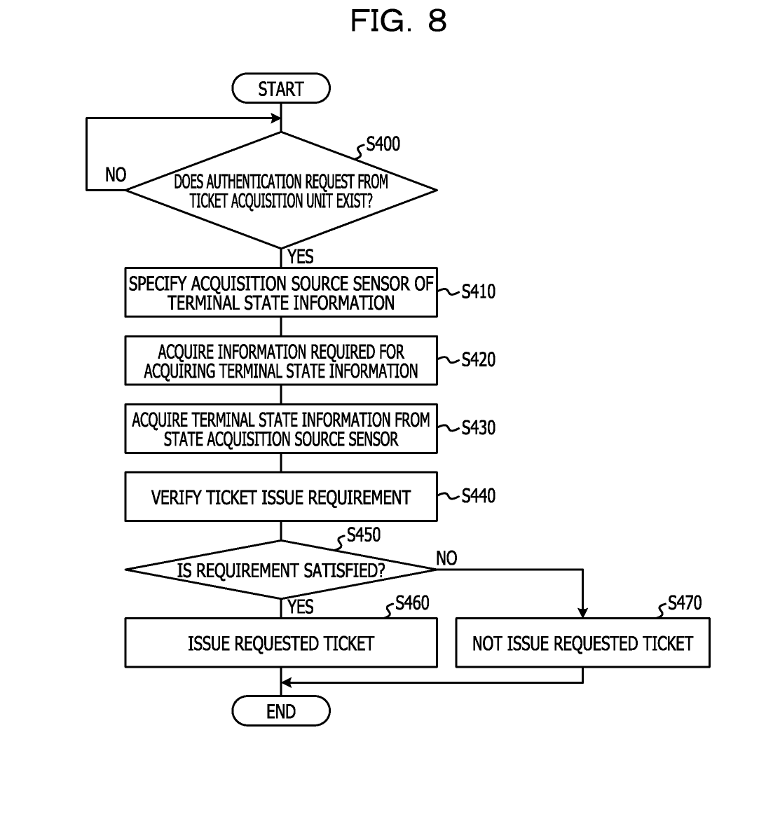

Next, an authentication process executed by the authentication server 120 will be described. FIG. 8 is an operational flowchart illustrating an authentication process executed by the authentication server 120.

As described above, the authentication server 120 includes a type that makes a ticket of the terminal state information acquired by the terminal apparatus 20 and a type that spontaneously transmits a ticket without the authentication request from the ticket acquisition unit 100. Further, there is an authentication server 120 of a type which issues a ticket by receiving the authentication request from the ticket acquisition unit 100. Herein, as an example, an operational flowchart of the authentication server 120 of the type which issues a ticket by receiving the authentication request from the ticket acquisition unit 100 is illustrated in FIG. 8.

First, at step S400, the authentication server 120 determines whether to the authentication request has been received from the ticket acquisition unit 100. In the case of a negative determination, the process proceeds to step S400 again to wait for receiving the authentication request. Meanwhile, in the case of a positive determination, the process proceeds to step S410.

At step S410, the authentication server 120 specifies a sensor that is to acquire the terminal state information, based on the acquisition source information of the ticket which is received together with the authentication request. This is because there may exist a plurality of sensors 70 being handled in the authentication server 120.

At step S420, when information required to acquire the ticket is notified from the ticket acquisition unit 100, the authentication server 120 acquires the information.

At step S430, the authentication server 120 inputs the information acquired at step S420 in the sensor 70 affiliated with the authentication server 120, which is specified at step S410, to acquire the terminal state information from the specific sensor 70 affiliated with the authentication server 120. Further, when there exist no information required to acquire the ticket, the authentication server 120 needs not input the information in the sensor 70 at the time of acquiring the terminal state information from the specific sensor 70 affiliated with the authentication server 120.

At step S440, the authentication server 120 verifies a ticket issue requirement by verifying whether the ticket requested by the ticket acquisition unit 100 and the terminal state information acquired from the sensor 70 affiliated with the authentication server 120 are consistent with each other.

For example, it is assumed that the sensor 70 is a sensor (time table sensor) that outputs a time table of a course, and the ticket requested by the ticket acquisition unit 100 is the mathematics remediation course ticket. Further, it is assumed that the time table sensor is a sensor that outputs which subject course is performed in an input class at an input time when a class name and time information are input as the terminal state information. In this case, although the ticket requested by the ticket acquisition unit 100 is the mathematics remediation course ticket, when the time table sensor outputs ‘Japanese’, it is determined that the ticket issue requirement is not satisfied due to a difference in subject.

Accordingly, as compared with the case where the ticket is issued without verifying the ticket issue requirement, reliability in authentication process may be improved. That is, reliability of the ticket used in the information processing system 10 may be further improved.

The authentication server 120 verifies the ticket issue requirement by referring to a ticket issue requirement table that prescribes in advance a correct relationship between the ticket requested by the ticket acquisition unit 100 and the terminal state information output from the sensor 70 affiliated with the authentication server 120.

When it is determined that the authentication server 120 satisfies the ticket issue requirement at step S450, the process proceeds to step S460, and when the authentication server 120 determines that the ticket issue requirement is not satisfied, the process proceeds to step S470.

Moreover, at step S460, the authentication server 120 makes a ticket of the terminal state information acquired from the sensor 70 affiliated with the authentication server 120 by the process of step S430, and transmits the ticket to the ticket acquisition unit 100.

Meanwhile, at step S470, since the ticket issue requirement for the requested ticket is not satisfied, the authentication server 120 transmits to the ticket acquisition unit 100 the notification indicating that the ticket has failed to be issued.

According to the above processes, the authentication process illustrated in FIG. 8 is ended.

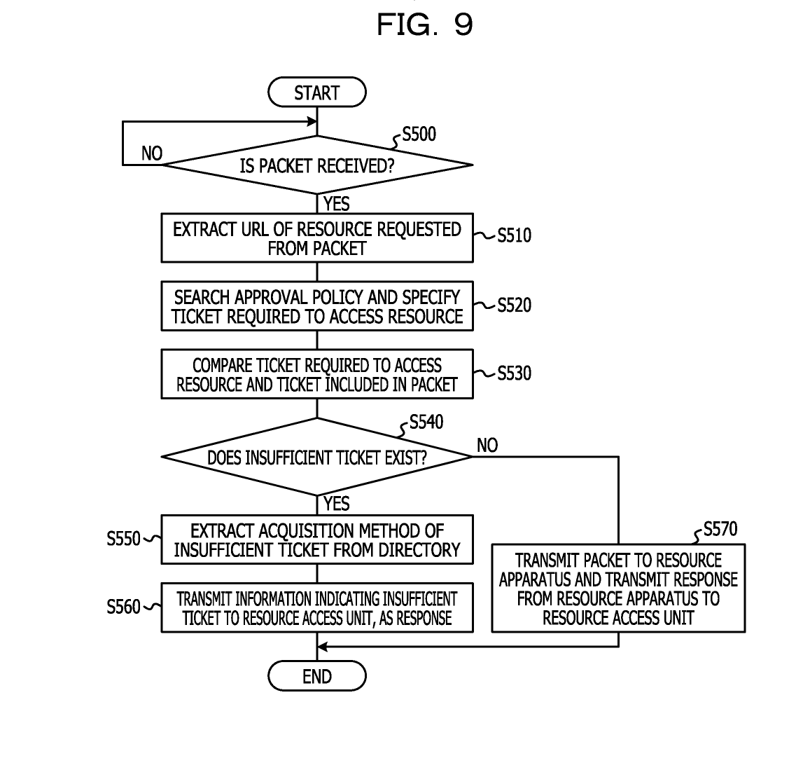

Next, an operation of the GW apparatus 30 according to the embodiment will be described. The ticket validation unit 160 of the GW apparatus 30 according to the embodiment executes a ticket validation process illustrated in FIG. 9 after activating the GW apparatus 30.

First, at step S500, the ticket validation unit 160 determines whether a packet has been received from the resource access unit 80 of the terminal apparatus 20. In addition, in the case of a negative determination, the process proceeds to step S500 again to wait for receiving the packet. Meanwhile, in the case of a positive determination, the process proceeds to step S510.

At step S510, the ticket validation unit 160 extracts a URL of the resource requested by the application unit 50 from the packet received by the process of step S500.

At step S520, the ticket validation unit 160 specifies a ticket (required ticket) required to access the URL of the resource extracted at step S510 by referring to the approval policy 286.

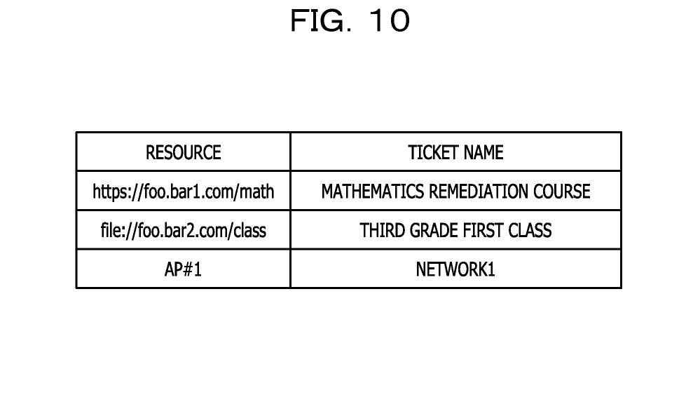

FIG. 10 is a diagram illustrating an example of the approval policy 286, and the approval policy 286 includes, for example, information that associates a URL of a resource with a ticket name required to access the URL of the resource.

In the example of the approval policy 286 illustrated in FIG. 10, it is disclosed that the mathematics remediation course ticket is required to access a resource of a mathematics remediation course textbook represented as, for example, http://foo.bar1.com/math.

The access to the resource includes an access to a network with which a connection is limited, in addition to an access to the data. For example, in the example of the approval policy 286 illustrated in FIG. 10, it is prescribed that a network1 ticket is required to access the network represented as “AP#1” with a limited connection, where “AP” is an abbreviation of “access point”.

The number of required tickets to access the resource is not limited to one. A plurality of required tickets may be needed.

At step S530, the ticket validation unit 160 compares the ticket added to the packet received by the process of step S500 and a required ticket specified by the process of step S520.

At step S540, the ticket validation unit 160 determines whether the insufficient ticket exists, among the required tickets specified by the process of step S520. In addition, in the case of a positive determination, the process proceeds to step S550.

At step S550, the ticket validation unit 160 acquires the acquisition source information of the ticket determined to be insufficient in the process of step S540, by referring to the directory 284.

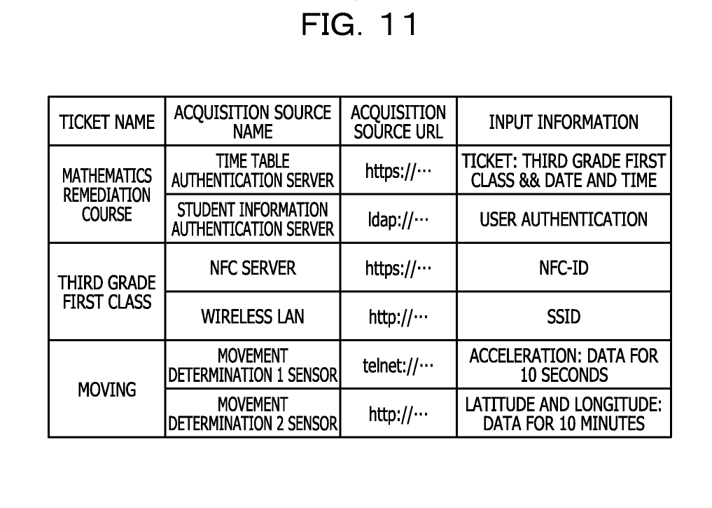

FIG. 11 is a diagram illustrating an example of the directory 284. The directory 284 includes information that stores a name of the ticket, a name of the ticket acquisition source, an acquisition source URL of the ticket, and input information indicating information required to acquire the ticket, in association with each other.

The example of the directory 284 illustrated in FIG. 11 indicates that the ticket for a third grade first class and date and time information are to be input in a time table authentication server represented as the URL of an acquisition source URL column, in order to acquire the mathematics remediation course ticket. Further, as another method for acquiring the mathematics supplementary education ticket, FIG. 11 indicates that user authentication information is to be input in a student information authentication server represented as the URL of the acquisition source URL column. Even in any authentication server, the same mathematics remediation course ticket may be acquired.

Similarly, FIG. 11 indicates that a ticket for the third grade first class may be acquired from any one of an NFC server and a wireless LAN, and a moving ticket may be acquired from any one of a movement determination 1 sensor and a movement determination 2 sensor.

As described above, when the plurality of acquisition sources exists for the same ticket, information on the plurality of acquisition sources is described in the directory 284.

The ticket validation unit 160 acquires all ticket acquisition methods corresponding to the insufficient tickets from the director y 284. Further, when a plurality of insufficient tickets exists, all ticket acquisition methods that are described in the directory 284 for the respective tickets are acquired.

At step S560, the ticket validation unit 160 generates a response in which the acquisition source information of the insufficient ticket is added to the header, based on the ticket acquisition method of the insufficient ticket acquired at step S550. For example, when it is determined that the mathematics remediation course ticket is insufficient, the ticket validation unit 160 generates a response in which acquisition source information based on a time table and student information is added to the header. In detail, the ticket validation unit 160 generates a response including the header illustrated in FIG. 4, which has already been described.

The ticket validation unit 160 transmits the generated response to the resource access unit 80 of the terminal apparatus 20.

Meanwhile, in the process of step S540, when it is determined that all of the required tickets required to access the resource requested by the packet are added, the process proceeds to step S570.

At step S570, the ticket validation unit 160 transmits the packet received in the process of step S500 to the resource apparatus 190 represented as the URL of the resource extracted in the process of step S510. In addition, the ticket validation unit 160 transmits the response received from the resource apparatus 190 to the resource access unit 80 of the terminal apparatus 20.

According to the above processes, the ticket validation process illustrated in FIG. 9 is ended.

As described above, the GW apparatus 30 detects whether a ticket required to access the requested resource is added to a packet when receiving the packet from the terminal apparatus 20, by referring to the approval policy 286. Moreover, when the ticket required to access the resource is insufficient, the GW apparatus 30 notifies the terminal apparatus 20 of an acquisition source from which the insufficient ticket is able to be acquired. In this case, when a plurality of acquisition sources of the insufficient ticket exists, the GW apparatus 30 notifies information on all of the acquisition sources.

Meanwhile, the terminal apparatus 20 calculates the acquisition cost of the ticket by referring to the acquisition cost table 250 based on the acquisition source information of the insufficient ticket, and acquires the insufficient ticket by giving priority to an acquisition source of a ticket having a small acquisition cost.

Therefore, since, at the time of acquiring the ticket, it is unnecessary to acquire a ticket from an acquisition source having a large acquisition cost, the load of processing in the terminal apparatus 20 may be suppressed.

The information processing system 10 may have a configuration in which a plurality of terminal apparatuses 20 is connected to the GW apparatus 30. In this case, the ticket validation unit 160 of the GW apparatus 30 temporarily stores transmission source information of the packet for each packet received from the terminal apparatus 20, to read the stored transmission source information at the time of transmitting the response corresponding to the packet.

Hereinabove, the disclosed technique has been described with reference to the embodiments, but the disclosed technique is not limited to the scope disclosed in the embodiments. Various changes or modifications of the embodiments may be made within the scope without departing from the spirit of the disclosed technique, and changed or modified forms are also included in the technical scope of the disclosed technique. For example, the order of the processing may be changed within the scope without departing from the spirit of the disclosed technique.

Although the aspect in which the in-terminal proxy program 238 and the GW proxy program 278 are memorized (installed) in the memory unit 226 and the storage unit 266 in advance, respectively, has been described as above, the present disclosure is not limited thereto. The in-terminal proxy program 238 and the GW proxy program 278 according to the disclosed technique may be provided in a form in which the in-terminal proxy program 238 and the GW proxy program 278 are recorded in a computer readable recording medium. For example, the in-terminal proxy program 238 and the GW proxy program 278 according to the disclosed technique may be provided in a form in which the in-terminal proxy program 238 and the GW proxy program 278 are recorded in portable recording media such as a CD-ROM, a DVD-ROM, and a USB memory. Further, the in-terminal proxy program 238 and the GW proxy program 278 according to the disclosed technique may be provided in a form in which the in-terminal proxy program 238 and the GW proxy program 278 are recorded in a semiconductor memory, such as a flash memory.

In the embodiment, the configuration in which the authentication server 120 is connected to the network 40 connected with the terminal apparatus 20, the GW apparatus 30, and the resource apparatus 190 are connected, has been described, but a connection form of the authentication server 120 is not limited thereto.

For example, the authentication server 120 may be connected to a network separated from the network 40. In this case, a manger different from managers of the terminal apparatus 20, the GW apparatus 30, and the resource apparatus 190 may manage the authentication server 120. Accordingly, a more flexible information processing system may be constructed and reliability associated with the ticket is improved. Further, a function of the GW apparatus 30 may be provided as a cloud service.

In the exemplary embodiment, the state of the terminal apparatus 20 is handled as the ticket, but the terminal state information before a ticket is made thereof may be used as information indicating the state of the terminal apparatus 20.

In this case, since the terminal state information need not be made as a ticket, the time required to acquire the terminal state information is expected to be shortened, and as a result, there is the case where the acquisition cost becomes lower. Meanwhile, as compared with the case where the state of the terminal apparatus 20 is handled as the ticket, there is a concern that the reliability of the entire information processing system 10 will deteriorate.

The following claims will be further disclosed in regard to the above embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal apparatus comprising:
a processor configured:
to transmit, to an information management apparatus, an access request for accessing access-target information stored in an external apparatus by adding first state information indicating a state of the terminal apparatus to the access request,
to receive a transmission request for requesting transmission of second state information indicating state information that is required for accessing the access-target information and currently insufficient for the information management apparatus, and
to execute an acquisition process of acquiring the second state information; and
a memory coupled to the processor, the memory being configured to store the received transmission request, wherein
when the second state information indicated by the transmission request is able to be acquired from a plurality of acquisition sources, the processor executes the acquisition process on the plurality of acquisition sources, by giving priority to an acquisition source that requires a relatively smaller load for acquiring the second state information in accordance with an acquisition load required for acquiring the second state information from each of the plurality of acquisition sources, and transmits the acquired second state information to the information management apparatus.

2. The terminal apparatus of claim 1, wherein
each of the first and second state information includes credit information indicating that a credit relationship is established with the information management apparatus.

3. The terminal apparatus of claim 2, wherein
the processor acquires the second state information from an authentication apparatus configured to generate the credit information.

4. The terminal apparatus of claim 1, wherein
the memory is configured to store the first state information indicating a state of the terminal apparatus; and
when the second state information is stored in the memory, the processor acquires the second state information from the memory and transmits the acquired second state information to the information management apparatus.

5. The terminal apparatus of claim 1, wherein
the acquisition load is set, based on a length of an acquisition time from a beginning of acquiring the second state information to an end of acquiring the second state information, so that the acquisition load becomes smaller as the acquisition time becomes shorter.

6. The terminal apparatus of claim 3, wherein
the processor acquires the second state information from the authentication apparatus via a communication line different from a communication line connected to the information management apparatus.

7. An information management apparatus comprising:
a processor configured:
to receive an access request for accessing access-target information stored in an external apparatus, and
to transmit, when state information required for accessing the access-target information is not added to the received access request, information on insufficient state information that is required for accessing the access-target information and currently insufficient for the information management apparatus, to a transmission source of the access request, together with information on an acquisition source from which the insufficient state information is to be acquired; and
a memory coupled to the processor, the memory being configured to store the received access request.

8. A non-transitory, computer-readable recording medium having stored therein a terminal program for causing a computer to execute a process, the process comprising:
transmitting, to an information management apparatus, an access request for accessing access-target information stored in an external apparatus by adding first state information indicating a state of the terminal apparatus to the access request;
receiving a transmission request for requesting transmission of second state information indicating state information that is required for accessing the access-target information and currently insufficient for the information management apparatus;
executing an acquisition process of acquiring the second state information; and
transmitting the acquired second state information to the information management apparatus, wherein,
when the second state information indicated by the transmission request received by the communication unit is able to be acquired from a plurality of acquisition sources, the acquisition process is executed on the plurality of acquisition sources, by giving priority to an acquisition source that requires a relatively smaller load for acquiring the second state information, in accordance with an acquisition load required for acquiring the second state information from each of the plurality of acquisition sources.

9. The non-transitory, computer-readable recording medium of claim 8, wherein
each of the first and second state information includes credit information indicating that a credit relationship is established with the information management apparatus.

10. The non-transitory, computer-readable recording medium of claim 9, wherein
the second state information is acquired from an acquisition source of an authentication apparatus configured to generate the credit information.

11. The non-transitory, computer-readable recording medium of claim 8, the process further comprises:
storing, in a memory, the first state information indicating a state of the terminal apparatus; and
when the second state information is stored in the memory, acquiring the second state information from the memory and transmitting the acquired second state information to the information management apparatus.

12. The non-transitory, computer-readable recording medium of claim 8, wherein
the acquisition load is set, based on a length of an acquisition time from a beginning of acquiring the second state information to an end of acquiring the second state information, so that the acquisition load becomes smaller as the acquisition time becomes shorter.

13. The non-transitory, computer-readable recording medium of claim 10, wherein
the second state information is acquired from the authentication apparatus via a communication line different from a communication line connected with the information management apparatus.

14. A non-transitory, computer-readable recording medium having stored therein an information management program for causing a computer to execute a process, the process comprising:
receiving an access request for accessing access-target information stored in an external apparatus; and
when state information required for accessing the access-target information is not added to the received access request, transmitting information on insufficient state information that is required for accessing the access-target information and currently insufficient for the information management apparatus, to a transmission source of the access request, together with information on an acquisition source from which the insufficient state information is to be acquired.

15. An information processing system comprising:
a storage unit configured to store access-target information;
a terminal apparatus configured:
to transmit, to an information management apparatus, an access request for accessing access-target information stored in an external apparatus by adding first state information indicating a state of the terminal apparatus to the access request,
to receive a transmission request for requesting transmission of second state information indicating state information that is required for accessing the access-target information and currently insufficient for the information management apparatus, and
to execute an acquisition process of acquiring the second state information, wherein, when the second state information indicated by the transmission request is able to be acquired from a plurality of acquisition sources, the terminal apparatus executes the acquisition process on the plurality of acquisition sources, by giving priority to an acquisition source that requires a relatively smaller load for acquiring the second state information in accordance with an acquisition load required for acquiring the second state information from each of the plurality of acquisition sources, and transmits the acquired second state information to the information management apparatus;
the information management apparatus configured:
to receive an access request for accessing access-target information stored in an external apparatus, and
to transmit, when state information required for accessing the access-target information is not added to the received access request, information on insufficient state information that is required for accessing the access-target information and currently insufficient for the information management apparatus, to a transmission source of the access request, together with information on an acquisition source from which the insufficient state information is to be acquired; and
an authentication apparatus configured to add credit information to the second state information and provide the second state information added with the credit information to the terminal apparatus.
